(19) United States
(12) Patent Application Publication
(10) Pub. No.: US 2020/0058101 A1
(43) Pub. Date: Feb. 20, 2020

(54) IMAGE PROCESSING DEVICE, IMAGING DEVICE, TERMINAL APPARATUS, IMAGE CORRECTION METHOD, AND IMAGE PROCESSING PROGRAM

(71) Applicant: SHARP KABUSHIKI KAISHA, Sakai City, Osaka (JP)

(72) Inventors: KEISUKE OMORI, Sakai City, Osaka (JP); KEI TOKUI, Sakai City, Osaka (JP)

(21) Appl. No.: 16/604,939

(22) PCT Filed: Jan. 10, 2018
(86) PCT No.: PCT/JP2018/000293

§ 371 Date: Oct. 11, 2019

(30) Foreign Application Priority Data
Apr. 13, 2017 (JP) 2017-079948

(51) Int. Cl. G06T 3/60; G06T 3/40

(52) U.S. Cl. CPC G06T 3/60; G06T 3/40

(57) ABSTRACT

An image processing device includes an image corrector configured to perform at least one correction of cut-out, rotation, and projective transformation on an input image to generate an output image, in which the image corrector is configured to perform the at least one correction based on an aspect ratio of the input image or the output image, or an orientation of an imaging device at a time when the input image is imaged.

### TECHNICAL FIELD

The present invention relates to an image processing device, an imaging device, a terminal apparatus, an image correction method, and an image processing program.

### BACKGROUND ART

There is an existing technique in which an image is subjected to rotation and/or cut-out by image processing and is corrected to a suitable image. According to the technique, for example, by rotating the image such that a horizontal line included in the image is parallel to a lateral direction of the image, the image can be corrected to an image that provides a stable impression to viewers. Furthermore, for example, by cutting out a noticeable imaging object included in the image so as to move to a prescribed position in the image, the image can be corrected to an image that provides a balanced impression to the viewers.

Examples of techniques for correcting images such as those described above include a technique disclosed in Patent Literature 1. The image processing device disclosed in Patent Literature 1 configures a composition pattern corresponding to the input image based on the number of noticeable areas noticed in the input image and a scene of the input image, and determines the optimum cut-out area in the input image based on the configured composition pattern. This allows an image with the optimum composition to be cut out.

### CITATION LIST

### Patent Literature

PTL 1: WO 2010/027080 (disclosed on Mar. 11, 2010)

### SUMMARY OF INVENTION

### Technical Problem

However, it would be useful in a case that a novel image processing device capable of generating a suitable output image is achieved.

An aspect of the present invention has been made in light of the above-described problem, and an object of the present invention is to achieve a novel image processing device capable of generating a suitable output image.

### Solution to Problem

In order to solve the above-described problem, an image processing device according to an aspect of the present invention includes an image corrector configured to perform at least one correction of cut-out, rotation, and projective transformation on an input image to generate an output image, in which the image corrector is configured to perform the at least one correction based on an aspect ratio of the input image or the output image, or an orientation of an imaging device at a time when the input image is imaged.

### Advantageous Effects of Invention

According to an image processing device according to an aspect of the present invention, an effect is exhibited in which a suitable output image can be generated.

### BRIEF DESCRIPTION OF DRAWINGS

FIG. 1 is a functional block diagram illustrating a configuration of main portions of an image processing device according to Embodiment 1.

FIG. 2 is a flowchart illustrating an example of operations performed by the image processing device according to Embodiment 1.

FIG. 3 is a diagram illustrating examples of representative compositions.

FIG. 4 is a diagram illustrating examples of input images and output images cut out therefrom.

FIG. 5 is a diagram illustrating examples of input images and output images cut out therefrom.

FIG. 6 is a diagram illustrating images each having a laterally long aspect ratio.

FIG. 7 is a diagram illustrating images each having a vertically long aspect ratio.

FIG. 8 is a diagram illustrating limitations of cut-off widths in images having different aspect ratios.

FIG. 9 is a functional block diagram illustrating a configuration of main portions of an image processing device according to Embodiment 3.

FIG. 10 is a flowchart illustrating an example of operations performed by the image processing device according to Embodiment 3.

FIG. 11 is a diagram illustrating a relationship between an aspect ratio and rotation accuracy.

FIG. 12 is a diagram illustrating a relationship between an aspect ratio and a rotation amount.

FIG. 13 is a functional block diagram illustrating a configuration of main portions of an imaging device including an image processing device according to Embodiment 5.

FIG. 14 is a flowchart illustrating an example of operations performed by the image processing device according to Embodiment 5.

FIG. 15 is a diagram illustrating an appearance of the imaging device according to Embodiment 5.

FIG. 16 is a diagram illustrating a state in which a photographer holds the imaging device according to Embodiment 5 to capture an imaging object.

FIG. 17 is a diagram illustrating captured images in cases that imaging objects are captured under the conditions illustrated in (a) and (b) of FIG. 16, respectively.

FIG. 18 is a block diagram illustrating a configuration of main portions of a terminal according to Embodiment 6.

### DESCRIPTION OF EMBODIMENTS

### Embodiment 1

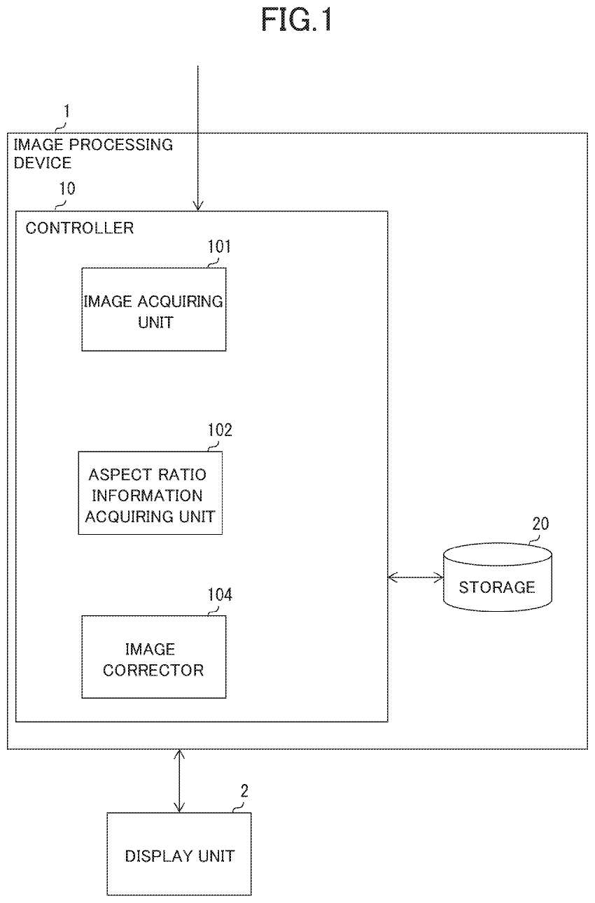

An image processing device 1 according to Embodiment 1 of the present invention will be described below in detail with reference to FIG. 1 to FIG. 7.

### 1. Configuration of Main Portions of Image Processing Device 1

FIG. 1 is a functional block diagram illustrating a configuration of main portions of the image processing device 1 according to the present embodiment. The image processing device 1 performs image processing for correcting a composition by performing cut-out on an input image input to the image processing device 1, and generates the corrected image (output image). The image processing device 1 is in radio connection or wired connection with a display unit 2. Furthermore, although not illustrated in the drawings, the image processing device 1 and the display unit 2 include a communication unit or a connection unit for achieving the radio connection or the wired connection.

The image processing device 1 includes a controller 10 and a storage 20. The controller 10 comprehensively controls the image processing device 1.

The controller 10 includes an image acquiring unit 101, an aspect ratio information acquiring unit 102, and an image corrector 104.

The image acquiring unit 101 acquires the input image.

The aspect ratio information acquiring unit 102 acquires information on an aspect ratio of the input image or the output image. The aspect ratio is a ratio between lengths of a side in a vertical direction and a side in a lateral direction of an image, and is expressed as the length of the side in the vertical direction: the length of the side in the lateral direction, or the length of the side in the lateral direction: the length of the side in the vertical direction. Note that in the present specification, by taking an up and down direction of the image as the vertical direction and a left and right direction of the image as the lateral direction, the aspect ratio is expressed as the length of the side in the lateral direction: the length of the side in the vertical direction. The aspect ratio information acquiring unit 102 acquires aspect ratio information of the input image from the input image acquired by the image acquiring unit 101. The aspect ratio of the output image may be the same aspect ratio as the input image, or may be the aspect ratio configured by the user.

Note that there are various types of aspect ratios, although there is no particular limitation, as representative examples, “4:3”, “3:2”, “1:1”, “16:9”, “21:9 (7:3)”, and the like are known.

The image corrector 104 detects, from the input image, imaging object information (for example, a representative position of the imaging object). The image corrector 104 corrects the input image based on the imaging object information and the aspect ratio acquired by the aspect ratio information acquiring unit 102, and generates an output image whose composition is corrected. Specifically, the image corrector 104 generates the image with a suitable corrected composition by performing cut-out on the input image in accordance with a determined composition. Note that the “representative position of the imaging object” is a position of any one point of the imaging object, for example, is the face of a person in a case that the imaging object is the person, is the center position of a substance in a case that the imaging object is the substance, and is a position of a noticeable imaging object in a case that multiple imaging objects are included.

Examples of the imaging object information in the input image include a wide variety of information such as a noticeable imaging object such as the face of a person or the like, edges and straight lines included in the input image, luminance distribution and color distribution, and the like. For example, in a case that the face in the input image is detected as the imaging object information in the input image, the imaging object information in the input image can be detected by using the existing technique, such as using information on a skin color area detected from the input image or the like.

The configuration in which the imaging object information in the input image is input to the image processing device 1 from the outside of the image processing device 1 may be employed. For example, a configuration can be adopted in which a user selects the imaging object on the input image displayed on the display unit 2, and a position of the selected imaging object is input to the image processing device 1 as the imaging object information in the input image. For example, in a case that the display unit 2 is a touch panel, the user can select the imaging object by touching the touch panel. Furthermore, the user may also select the imaging object in the input image by operating a mouse or a keyboard.

The storage 20 is configured to store various control programs and the like performed by the image processing device 1, for example, and includes a non-volatile storage device such as a hard disk and a flash memory. The storage 20 stores the input image and the output image, for example. Additionally, the storage 20 may store parameters and the like necessary for the processing of the image processing device 1, such as the image processing (composition correction processing), imaging object detection processing, and the like.

### 2. Operation of Image Processing Device 1

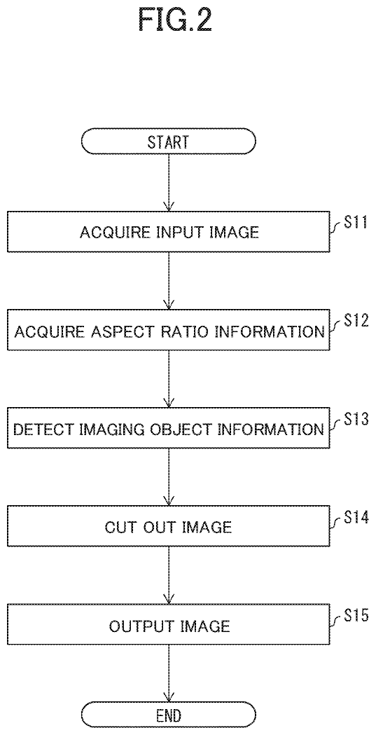

FIG. 2 is a flowchart illustrating an example of operations performed by the image processing device 1.

Step S11

First, the image acquiring unit 101 acquires an input image. The image acquiring unit 101 supplies the acquired input image to the aspect ratio information acquiring unit 102 and the image corrector 104.

Step S12

Next, the aspect ratio information acquiring unit 102 acquires information on an aspect ratio of the input image or an output image. The aspect ratio information acquiring unit 102 supplies the acquired aspect ratio information to the image corrector 104.

Step S13

Next, the image corrector 104 detects, from the input image, imaging object information.

Step S14

Next, the image corrector 104 cuts out an image from the input image based on the imaging object information detected in step S13 and the aspect ratio information acquired in step 12, and generates an output image whose composition are corrected.

Step S15

Next, the image corrector 104 causes the display unit 2 to output the generated output image.

### 3. One Example of Correction

The correction performed by the image corrector 104 of the image processing device 1 will be specifically described below. The image corrector 104 cuts out an image from the input image based on the imaging object information and the aspect ratio of the input image or the output image, and corrects the composition. In a case that the composition is corrected based on the imaging object information and the aspect ratio, the image corrector 104 performs, in a case that the aspect ratio of the input image and the aspect ratio of the output image are the same, composition correction in consideration of the aspect ratio of the input image (=the aspect ratio of the output image), and performs, in a case that the aspect ratio of the input image and the aspect ratio of the output image are different, composition correction in consideration of the aspect ratio of the output image. Hereinafter, a case that the aspect ratio of the input image and the aspect ratio of the output image are the same, that is, the composition correction in consideration of the aspect ratio of the input image will be specifically described.

### Composition

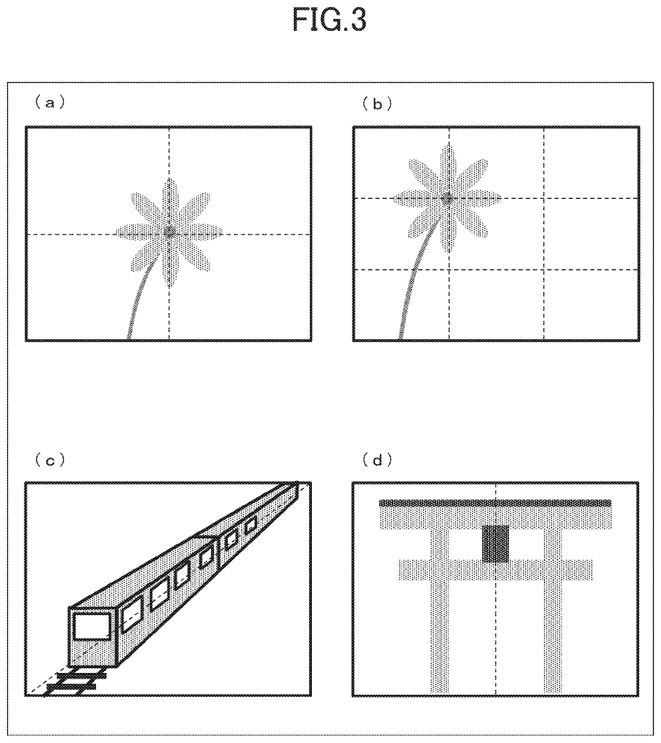

There are various types of compositions. FIG. 3 illustrates examples of representative compositions. (a) of FIG. 3 illustrates a Centered Composition, (b) of FIG. 3 illustrates a rule of thirds composition, (c) of FIG. 3 illustrates a diagonal line composition, and (d) of FIG. 3 illustrates a symmetry composition.

The centered composition in (a) of FIG. 3 is a composition in which a main imaging object is located at the center of the image. The rule of thirds composition in (b) of FIG. 3 is a composition in which a main imaging object or a main line (for example, a horizontal line or the like) is located on a line among lines that divide the image in three parts in the vertical direction and the lateral direction, or on an intersection point of these lines. The diagonal line composition in (c) of FIG. 3 is a composition in which an imaging object, a straight line, or the like is located on a diagonal line of the image. The symmetry composition in (d) of FIG. 3 is a composition to be linearly symmetrical with respect to the center line of the image. In addition, although not illustrated in the drawings, in addition to these, a frame composition in which the periphery of the main imaging object is surrounded, a sandwich composition in which the main imaging object are sandwiched by other imaging objects from both sides, a tunnel composition in which portions other than the main imaging object is darkened, a radial composition having a vanishing point, and the like are known. Additionally, a composition in which a horizontal line in the image is parallel to the lateral direction of the image is also considered to be one of the compositions. These compositions do not need to be independent of each other, and a combination of two or more types of compositions can be used. For example, a composition that is the centered composition and is the symmetry composition can be obtained.

### Cutting Out Based on Composition

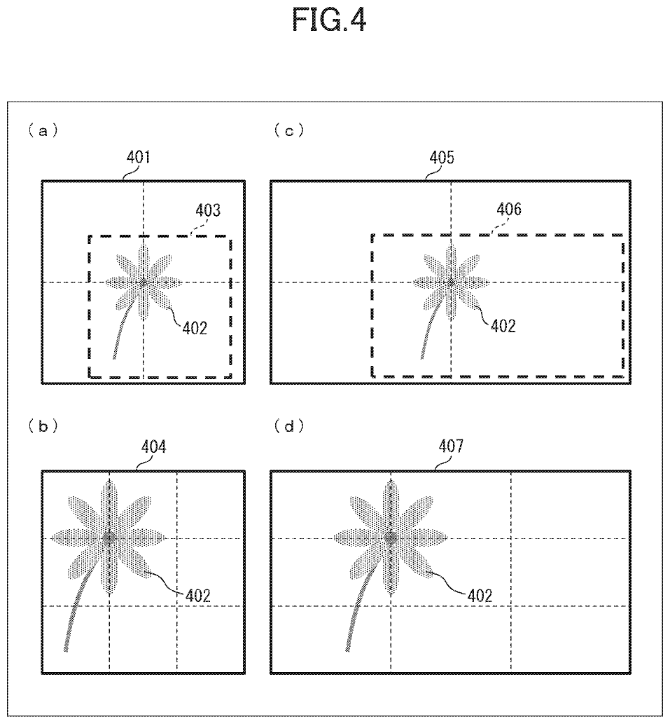

An example in a case that an image with the rule of thirds composition is cut out from an input image (imaged image) and an output image is generated will be described. FIG. 4 includes diagrams illustrating examples of input images (imaged images) and output images cut out therefrom. An input image 401 illustrated in (a) of FIG. 4 has the centered composition in which a representative position of an imaging object 402 (specifically, the center of a flower) is located at the center of the image. The aspect ratio of the input image 401 is 1:1. In a case that an image with the rule of thirds composition is cut out from the input image 401, for example, an area 403 surrounded by a rectangular dashed line in the image 401 serves as a cut-out area. The aspect ratio of the cut-out area 403 is the same as the aspect ratio of the output image, and is 1:1 in this case. The image that is cut out is an output image 404 illustrated in (b) of FIG. 4. The output image 404 has a composition in which the representative position of the imaging object 402 is located on an upper left point obtained by dividing the image in three parts.

On the other hand, in the same manner as the input image 401, an input image 405 illustrated in (c) of FIG. 4 has the centered composition in which the representative position of the imaging object 402 (specifically, the center of a flower) is located at the center of the image. The aspect ratio of the input image 405 is 16:9. In a case that an image with the rule of thirds composition is cut out from the input image 405 as described above, for example, an area 406 surrounded by a rectangular dashed line in the image 405 serves as a cut-out area. The aspect ratio of the cut-out area 406 is the same as the aspect ratio of the output image, and is 16:9 in this case. The image that is cut out is an output image 407 illustrated in (d) of FIG. 4. In the same manner as the output image 404, the output image 407 has a composition in which the representative position of the imaging object 402 is located on an upper left point obtained by dividing the image in three parts.

In an aspect, the image corrector 104 cuts out the output image with the rule of thirds composition in which the imaging object is located on the upper left point obtained by dividing in three parts as illustrated in FIG. 4, as described below. In a case that, a lateral width is taken as w0 and a vertical width is taken as h0 of the input image, and a position of the imaging object in the input image is taken as (x0, y0), and in a case that, of the cut-out area, a position of a point on an upper left corner is taken as (x1, y1), a lateral width is taken as w1, and a vertical width is taken as h1, the image corrector 104 determines x1, y1, w1, and h1 (all equal to or more than 0) such that Equations (1) and (2) and the following relationships are satisfied, and generates output image data from data of each pixel in the cut-out area.

x1+w1/3=x0 (1)

y1+h1/3=y1 (2)

x1+w1≤w0 (3)

y1+h1≤h0 (4)

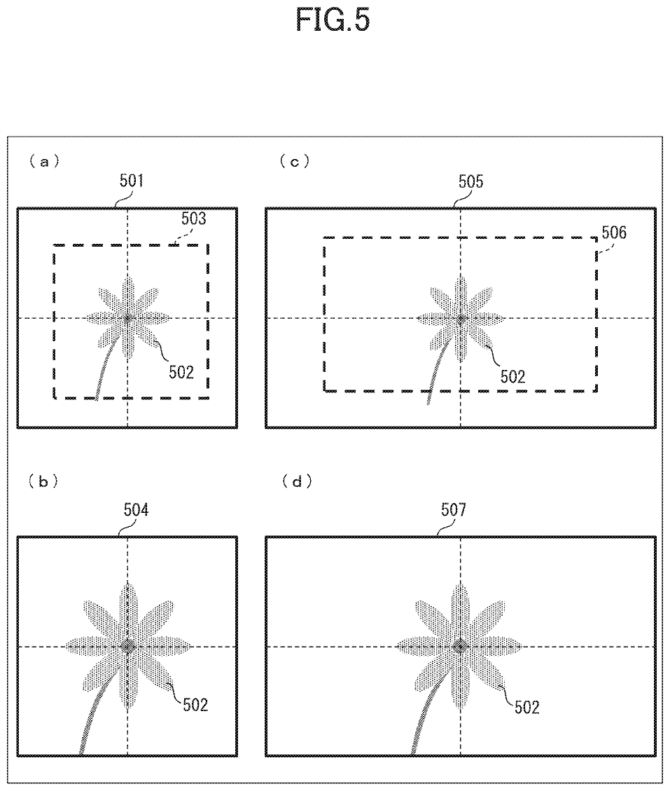

Next, an example in a case that an image with the centered composition is cut out from an input image (imaged image) and an output image is generated will be described. FIG. 5 includes diagrams illustrating examples of input images (imaged images) and output images cut out therefrom. An input image 501 illustrated in (a) of FIG. 5 has the centered composition in which a representative position of an imaging object 502 (specifically, the center of a flower) is located at the center of the image. The aspect ratio of the input image 501 is 1:1. In a case that an image with the centered composition is cut out from the input image 501, for example, an area 503 surrounded by a rectangular dashed line in the input image 501 serves as a cut-out area. The aspect ratio of the cut-out area 503 is the same as the aspect ratio of the output image, and is 1:1 in this case. The image that is cut out is an output image 504 illustrated in (b) of FIG. 5. The output image 504 has a composition in which the representative position of the imaging object 502 is located at the center of the image.

On the other hand, in the same manner as the input image 501, an input image 505 illustrated in (c) of FIG. 5 has the centered composition in which the representative position of the imaging object 502 is located at the center of the image. The aspect ratio of the input image 505 is 16:9. In a case that an image with the centered composition is cut out from the input image 505, for example, an area 506 surrounded by a rectangular dashed line in the image 505 serves as a cut-out area. The aspect ratio of the cut-out area 506 is the same as the aspect ratio of the output image, and is 16:9 in this case. The image that is cut out is an output image 507 illustrated in (d) of FIG. 5. In the same manner as the output image 504, the output image 507 has a composition in which the representative position of the imaging object 502 is located at the center of the image.

In an aspect, the image corrector 104 cuts out the output image with the centered composition as illustrated in FIG. 5, as described below. In a case that, a lateral width is taken as w0 and a vertical width is taken as h0 of the input image, and a position of the imaging object in the input image is taken as (x0, y0), and in a case that, of the cut-out area, a position of a point on an upper left corner is taken as (x1, y1), a lateral width is taken as w1, and a vertical width is taken as h1, the image corrector 104 determines x1, y1, w1, and h1 (all equal to or more than 0) such that the relationships described above and Equations (5) and (6) are satisfied, and generates output image data from data of each pixel in the cut-out area.

x1+w1/2=x0 (5)

y1+h1/2=y1 (6)

In a case of generating an output image with another composition as well, in the same manner, the image corrector 104 may determine a cut-out area such that the position of the imaging object matches the composition in the output image, and generate the output image data from the data of each pixel in the cut-out area. Additionally, in an aspect, the image corrector 104 may rotate the input image and perform the cut-out, or may use an image obtained by rotating the cut-out image as the output image.

Furthermore, in another aspect, the image on which the cut-out is performed may be an input image, or may be a transformed image obtained by performing rotation, enlargement and reduction, geometric transformation, or the like on the input image.

Furthermore, in another aspect, in the cutting out, a cut-out area having a shape other than the rectangle may be configured and an image having the shape other than the rectangle may be cut out from the input image. For example, images having a shape such as a circular shape, an elliptical shape, a parallelogram shape, or the like may be cut out depending on the application.

### Determination Method of Composition

Here, an evaluation method of the composition is described. As described above, there are multiple types of compositions, and there are compositions with different evaluation methods. For example, in the centered composition, the main imaging object is important, and by detecting the main imaging object and evaluating the position and size thereof, it is possible to evaluate whether or not an image is suitable for the centered composition. In the rule of thirds composition as well, the position of the imaging object is important. Furthermore, in the symmetry composition, by evaluating line symmetry of the imaging object, it is possible to evaluate whether or not it has a symmetry composition. Furthermore, by detecting a straight line in the image and evaluating a tilt of the straight line, evaluation on horizontality and the diagonal line composition can be performed. Furthermore, the tunnel composition can be evaluated using the position of the imaging object and luminance distribution. The image corrector 104 can generate an image with a suitable composition by evaluating the input image with multiple evaluation indexes and determining a composition of the output image.

Furthermore, the size of the cut-out area of the image is also one of the evaluation indexes. In a case that the cut-out area is extremely narrow, an angle of view of the output image is narrow with respect to an angle of view of the captured image, and thus the output image may have a composition different from the intention of the photographer. For example, in a case that a small imaging object with high symmetry is included in the input image, in a case that only the imaging object is cut out, symmetry of the output image increases, but the angle of view narrows and resolution decreases. Accordingly, for example, as the ratio of the angle of view of the output image to the angle of view of the input image increases, by increasing the evaluation, a composition with a wide angle of view is easily selected, which is suitable.

Furthermore, a rotation angle is also one of the evaluation indexes. Since the input image is likely to be captured in the orientation of the imaging object intended by the photographer, although there is a possibility that the imaging object may be slightly tilted due to camera shake or depending on photographing technique of the photographer, it is unlikely that the image is captured with an extremely large tilt relative to the orientation of the imaging object intended by the photographer. Accordingly, for example, as the tilt of the imaging object of the output image to the orientation of the imaging object of the input image increases, by decreasing the evaluation, a composition with the imaging object extremely tilted to the input image is less easily selected, which is suitable.

Additionally, the image corrector 104 may evaluate the composition in consideration of image information such as the number of pixels of the input image or the like and imaging information such as a focus position at the time of capturing the input image or the like. Note that the configuration in which the image information and the imaging information as described above are input to the image processing device 1 along with the input image from the outside of the image processing device 1 may be employed. Furthermore, the image information such as the number of pixels of the input image or the like may be calculated by the image corrector 104 based on the input image, or the image processing device 1 may be configured to further include an image information calculation unit (not illustrated) and the image information calculation unit may calculate the image information such as the number of pixels or the like based on the input image.

Although the evaluation method of the composition has been described using the example, in the present embodiment, an output image with a suitable composition is generated by further correcting the composition in consideration of the aspect ratio of the image.

As a correction method of the composition in consideration of the aspect ratio of the image, for example, by increasing the evaluation of a specific composition in accordance with the aspect ratio of the image, it is possible to vary ease of selection of each of the compositions. In one embodiment, the image corrector 104 may add an additional score based on the aspect ratio to the score calculated based on a criterion other than the aspect ratio (for example, line symmetry of the imaging object or the like), and select a composition with the highest score.

For example, in a case that the aspect ratio of the input image is 1:1, the output image 404 ((b) of FIG. 4), which is corrected to have the rule of thirds composition, has no space from the imaging object 402 to an image end on a left side and has a composition that provides a cramped impression. On the other hand, the output image 504 ((b) of FIG. 5), which is corrected to have the centered composition, has a composition in which the representative position of the imaging object 502 is located at the center of the image and presence thereof is emphasized. As described above, in a case that the aspect ratio of the input image is 1:1, it can be said that the centered composition is a composition that provides a suitable impression.

Furthermore, in a case that the aspect ratio of the input image is 16:9, the output image 507 ((d) of FIG. 5), which is corrected to have the centered composition, has a composition that provides impression that the imaging object 502 has weak presence, because the representative position of the imaging object 502 is located at the center of the image, but there are large spaces on the left and right of the imaging object 502. On the other hand, the output image 407 ((d) of FIG. 4), which is corrected to have the rule of thirds composition, has a large space on a right side of the imaging object 402, also has a space on the left side, and thus has a balanced composition. As described above, in a case that the aspect ratio of the input image is 16:9, it can be said that the rule of thirds composition is a composition that provides a suitable impression.

As described above, all of the input images 401, 405, 501, 505 are images captured such that the imaging object 402 is located at the center of the image, but depending on the aspect ratio of the input image, the composition having the suitable impression varies.

In an aspect, in a case that the image aspect ratio is 1:1, the image corrector 104 adds the additional score to the score of the centered composition. This increases the possibility that the centered composition is evaluated as a suitable composition compared with a laterally long composition. Additionally, in an aspect, the image corrector 104 may increase an evaluation value of the centered composition as the aspect ratio of the input image approaches 1:1 in the composition. This makes it easier to select the centered composition in a case of the aspect ratio close to a square, and the laterally longer the aspect ratio is, the less likely the centered composition is to be selected.

Furthermore, in another aspect, depending on the aspect ratio of the image, a specific composition may not be selected. For example, in a case that the aspect ratio of the image is laterally long, such as 21:9, the image corrector 104 may perform subtraction of the score of the centered composition. In a case that the aspect ratio of the image is laterally longer than a predetermined ratio, since it is less likely that the centered composition becomes a preferable composition, causing the centered composition not to be selected makes it easier for other preferred compositions to be selected.

In addition, in the same manner, in the rule of thirds composition as well, for example, in an aspect, in a case that the aspect ratio of the image is laterally long, the image corrector 104 adds an additional score based on the aspect ratio to the score of the rule of thirds composition, whereby, as the aspect ratio of the image becomes laterally longer (in a case that the aspect ratio of the image is 21:9 in comparison with a case of 16:9), in the rule of thirds composition, the possibility that a composition in which the image is divided into two parts in the vertical direction is evaluated as a suitable composition can be increased in comparison with a composition in which the image is divided into three parts in the vertical direction. In addition, for example, in a case that the aspect ratio of the image is vertically long, the image corrector 104 adds an additional score based on the aspect ratio to the score of the rule of thirds composition, whereby, as the aspect ratio of the image becomes vertically longer (in a case that the aspect ratio of the image is 9:21 in comparison with a case of 9:16), in the rule of thirds composition, the possibility that a composition in which the image is divided into two parts in the lateral direction is evaluated as a suitable composition can be increased in comparison with a composition in which the image is divided into three parts in the lateral direction.

Furthermore, in a case that the rule of thirds composition is used as the composition of the output image, the image corrector 104 may use, in accordance with the aspect ratio of the image, instead of the rule of thirds composition described above, a modified rule of thirds composition in which the main imaging object is located on an intersection point of lines that divide the image into three parts in the long side direction and a line that divides the image into two parts in the short side direction.

In an aspect, in a case that the aspect ratio indicates being laterally longer than a threshold value, the image corrector 104 determines, as a composition of the output image, the modified rule of thirds composition in which the main imaging object is located on the intersection point of lines that divide the image into three parts in the lateral direction and a line that divides the image into two parts in the vertical direction.

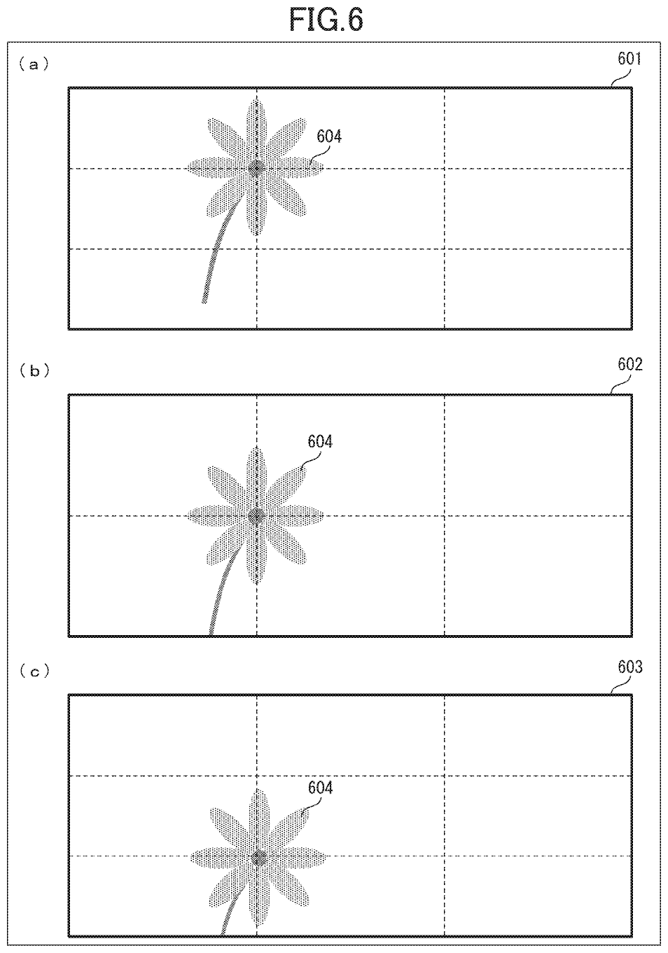

(a), (b) and (c) of FIG. 6 illustrate output images 601, 602, and 603, respectively, after the composition correction with the aspect ratio of 21:9, and the same imaging object 604 is included in each drawing. In the output image 601, the imaging object 604 is located at an upper left point obtained by dividing into three parts in each of the vertical direction and the lateral direction. In the output image 602, the imaging object 604 is located at a point on a left side obtained by dividing into two parts in the vertical direction and dividing into three parts in the lateral direction. In the output image 603, the imaging object 604 is located at a lower left point obtained by dividing into three parts in each of the vertical direction and the lateral direction. In the image having the aspect ratio that is laterally long as illustrated in FIG. 6, as illustrated in the output images 601 and 603, in a case that the imaging object is located at the position obtained by dividing into three parts in the vertical direction, which is a short side direction of the output image, the output image that gives an impression that the imaging object is brought close to the image end is obtained. On the other hand, as illustrated in the output image 602, in a case that the imaging object is located at the position obtained by dividing into two parts in the short side direction of the output image, the imaging object is located at the position in a good balance in the up and down direction and obtained by dividing into three parts in the left and right direction, and thus a more suitable rule of thirds composition is obtained.

Furthermore, in an aspect, in a case that the aspect ratio indicates being vertically longer than a threshold value, the image corrector 104 determines, as a composition of the output image, the modified rule of thirds composition in which the main imaging object is located on the intersection point of a line that divides the image into two parts in the lateral direction and lines that divide the image into three parts in the vertical direction.

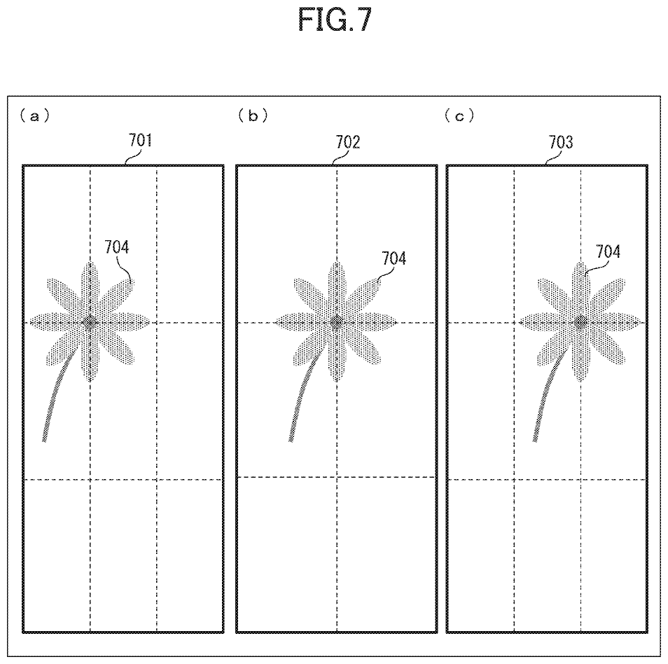

(a), (b) and (c) of FIG. 7 illustrate output images 701, 702, and 703, respectively, after the composition correction with the aspect ratio of 9:21, and the same imaging object 704 is included in each drawing. In the output image 701, the imaging object 704 is located at an upper left point obtained by dividing into three parts in each of the vertical direction and the lateral direction. In the output image 702, the imaging object 704 is located at a point on an upper side obtained by dividing into three parts in the vertical direction and dividing into two parts in the lateral direction. In the output image 703, the imaging object 704 is located at an upper right point obtained by dividing into three parts in each of the vertical direction and the lateral direction. In the image having the aspect ratio that is vertically long as illustrated in FIG. 7, as illustrated in the output images 701 and 703, in a case that the imaging object is located at the position obtained by dividing into three parts in the lateral direction, which is a short side direction of the output image, the output image that gives an impression that the imaging object is brought close to the image end is obtained. On the other hand, as illustrated in the output image 702, in a case that the imaging object is located at the position obtained by dividing into two parts in the short side direction of the output image, the imaging object is located at the position in a good balance in the left and right direction and obtained by dividing into three parts in the up and down direction, and thus a more suitable rule of thirds composition is obtained.

### Embodiment 2

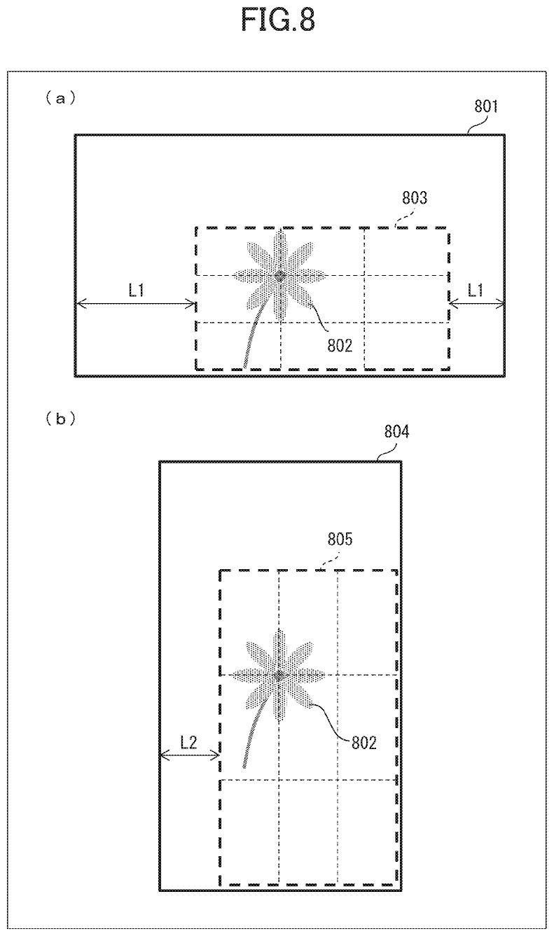

Embodiment 2 of the present invention will be described below with reference to FIG. 8. Note that for the sake of convenience of description, members having the same function as the members described in the above embodiment are denoted by the same reference signs, and descriptions thereof will be omitted. An image processing device according to the present embodiment has the same configuration as that of the image processing device 1 according to Embodiment 1, and is different therefrom in the operation of the image corrector 104.

In the present embodiment, the image corrector 104 may limit a cut-off width of the input image in the cutting out in accordance with the aspect ratio of the input image. That is, the image corrector 104 may configure the maximum value of a ratio of the cut-off width in the cutting out to the width of the input image in accordance with the aspect ratio of the input image, and may configure the ratio of the cut-off width at the time of cutting out the output image from the input image to the width of the input image to be equal to or less than the maximum value.

Note that the reasons why it is preferable to limit the cut-off width of the input image are as follows. For example, in a case that the aspect ratio of the input image is vertically long, it is expected that a margin on a lateral side of the main imaging object (a distance between the imaging object and the image end) is small, and in a case that the cutting out is performed with a large cut-out width in the lateral direction, a part of the main imaging object is located out of the cut-out area in the output image, and thus there is a possibility that the image quality deteriorates. Additionally, in a case that the aspect ratio of the input image is laterally long, it is expected that a margin on a vertical side of the main imaging object is small, and in a case that the cutting out is performed with a large cut-out width in the vertical direction, a part of the main imaging object is located out of the cut-out area in the output image, and thus there is a possibility that the image quality deteriorates. As described above, in a case that the cut-out width on the short side of the input image is large, there is the possibility that the image quality deteriorates. In particular, as the ratio of the length in the long side direction to the length in the short side direction is higher in the image, it is preferable that the maximum value of the cut-off width in the short side direction (lateral direction in the case of being vertically long, and the vertical direction in the case of being laterally long) be reduced. On the other hand, since it is less likely that the main imaging object is located at the end portion in the long side direction (the left and right ends in the case of being laterally long and the top and bottom ends in the case of being vertically long) of the image, the cut-out width in the long side direction can be increased to some extent. Accordingly, as the aspect ratio of the input image is vertically longer, it is preferable to configure the maximum value of the ratio of the cut-off width in the lateral direction to the width of the input image to be smaller than that in the case that the aspect ratio of the input image is laterally long. In the same manner, as the aspect ratio of the input image is laterally longer, it is preferable to configure the maximum value of the ratio of the cut-off width in the vertical direction to the width of the input image to be smaller than that in the case that the aspect ratio of the input image is vertically long.

In an aspect, as illustrated in (a) of FIG. 8, in a case that an input image 801 including a main imaging object 802 is laterally long, the image corrector 104 (i) determines that the input image 801 is laterally long based on the aspect ratio of the input image 801, (ii) configures the maximum value of a ratio of a cut-off width L1 in the lateral direction for cutting out an cut-out area 803 from the input image 801 to the width of the input image to a predetermined value, for example, (iii) configures the cut-out area 803 such that the ratio of the cut-off width L1 to the width of the input image is equal to or less than the maximum value, and then (iv) cuts out the cut-out area 803 from the input image 801 to generate an output image.

Additionally, as illustrated in (b) of FIG. 8, in a case that an input image 804 including the main imaging object 802 is vertically long, the image corrector 104 (i) determines that the input image 804 is vertically long based on the aspect ratio of the input image 804, (ii) configures the maximum value of a ratio of a cut-off width L2 in the vertical direction for cutting out an cut-out area 805 from the input image 804 to the width of the input image to a predetermined value, for example, (iii) configures the cut-out area 805 such that the ratio of the cut-off width L2 to the width of the input image is equal to or less than the maximum value, and then (iv) cuts out the cut-out area 805 from the input image 804 to generate an output image. In a case of comparing the ratio of the cut-off width L1 in the lateral direction to the lateral width of the input image 801 and the ratio of the cut-off width L2 in the lateral direction to the lateral width of the input image 804, the ratio of the cut-off width L2 in the lateral direction to the lateral width of the input image 804 is smaller. In other words, in (b) of FIG. 8, an image obtained by a smaller cut-off width is output as the output image.

According to the configuration described above, it is possible to suitably avoid that part of the main imaging object 802 disappears from the output image and the image quality deteriorates.

Note that in another aspect, the image corrector 104 may limit the cut-off width of the input image in the cutting out in accordance with the orientation of the imaging device at the time of having imaged the input image, instead of the aspect ratio of the input image.

The imaging device generally images a vertically long image or a laterally long image, in accordance with the orientation of the imaging device during imaging. The imaging device includes, for example, an acceleration sensor that measures an orientation of acceleration (gravity) with respect to the imaging device, and with this, can acquire information related to the orientation of the imaging device during imaging. In an aspect, the imaging device can impart information indicating the orientation of the imaging device at the time of having imaged the input image to the input image as metadata. In this case, the image corrector 104 can acquire the orientation of the imaging device at the time of having imaged the input image from the metadata. Furthermore, in another aspect, the image corrector 104 is connected to the imaging device or is incorporated into the imaging device, and can receive the information indicating the orientation of the imaging device at the time of having imaged the input image from the imaging device.

In an aspect, in a case that the orientation of the imaging device at the time of having imaged the input image is an orientation in which a vertically long image is to be imaged, the image corrector 104 may perform processing in a manner similar to the case that the aspect ratio of the input image is vertically long described above. Furthermore, in a case that the orientation of the imaging device at the time of having imaged the input image is an orientation in which a laterally long image is to be imaged, the image corrector 104 may perform processing in a manner similar to the case that the aspect ratio of the input image is laterally long described above.

### Embodiment 3

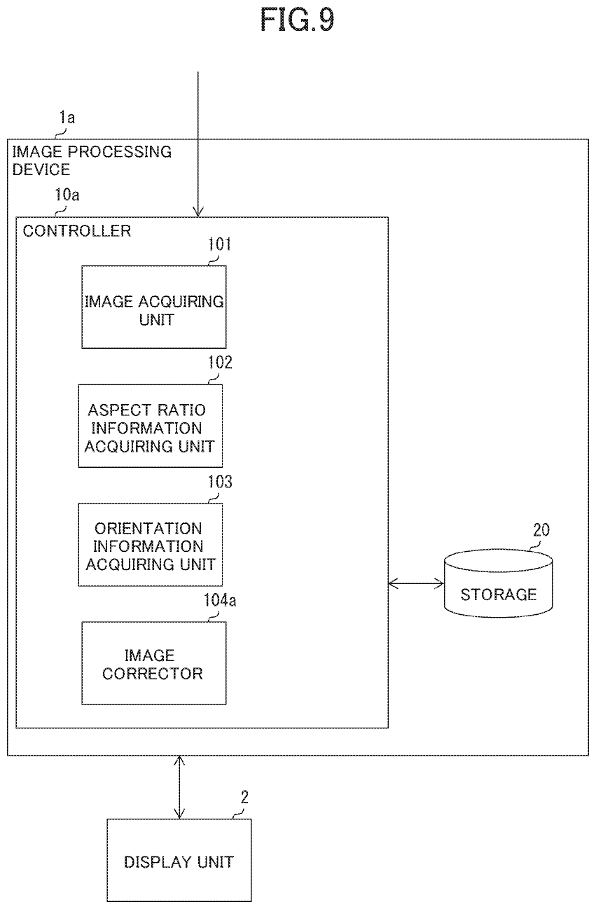

An image processing device 1a according to Embodiment 3 of the present invention will be described below in detail with reference to FIG. 9 to FIG. 11. Note that for the sake of convenience of description, members having the same function as the members described in the above embodiments are denoted by the same reference signs, and descriptions thereof will be omitted.

### 1. Configuration of Main Portions of Image Processing Device 1a

FIG. 9 is a functional block diagram illustrating a configuration of main portions of the image processing device 1a according to the present embodiment. The image processing device 1a performs image processing for rotating an image on an input image input to the image processing device 1a, and generates an image after correction (output image). As illustrated in FIG. 9, the image processing device 1a differs from the image processing device 1 according to Embodiment 1 in points that a controller 10a includes an image corrector 104a instead of the image corrector 104, and further includes an orientation information acquiring unit 103. With the configuration described above, the image processing device 1a is capable of switching rotation accuracy of the input image in accordance with the aspect ratio of the input image or the output image, or the orientation of the imaging device at the time of having imaged the input image.

The orientation information acquiring unit 103 acquires orientation information indicating the orientation of the imaging device at the time of having imaged the input image (whether the imaging device was in a portrait orientation (orientation in which the vertically long image is imaged) or in a landscape orientation (orientation in which the laterally long image is imaged)). For the orientation of the imaging device at the time of having imaged the input image, the orientation of the acceleration (gravity) with respect to the imaging device is measured, and this can be used as information relating to the orientation of the imaging device at the time of having imaged the input image. The orientation of the acceleration (gravity) with respect to the imaging device can be measured, for example, by an acceleration sensor included in the imaging device. With this, the information on whether the orientation of the imaging device at the time of having imaged the input image is the portrait orientation or the landscape orientation is acquired.

The image corrector 104a determines the rotation accuracy of the input image based on the aspect ratio information acquired by the aspect ratio information acquiring unit 102 or the orientation information acquired by the orientation information acquiring unit 103. Furthermore, the image corrector 104a detects horizontal direction information to be a clue to the horizontal direction in the input image, and determines a rotation amount by which the image is rotated based on the determined rotation accuracy and the horizontal direction information. Furthermore, the image corrector 104a rotates the input image based on the determined rotation amount, and generates a rotationally corrected output image.

### 2. Operation of Image Processing Device 1a

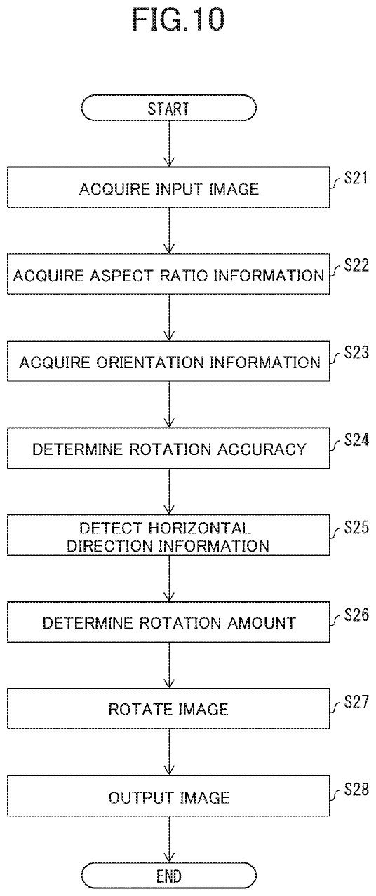

FIG. 10 is a flowchart illustrating an example of operations performed by the image processing device 1a.

Step S21

First, the image acquiring unit 101 acquires an input image. The image acquiring unit 101 supplies the acquired input image to the aspect ratio information acquiring unit 102 and the image corrector 104a.

Step S22

Next, the aspect ratio information acquiring unit 102 acquires information on an aspect ratio of the input image or an output image. The aspect ratio information acquiring unit 102 supplies the acquired aspect ratio information to the image corrector 104a.

Step S23

Next, the orientation information acquiring unit 103 acquires orientation information indicating the orientation of the imaging device at the time of having imaged the input image (whether the imaging device is in the portrait orientation or in the landscape orientation). The orientation information acquiring unit 103 supplies the acquired orientation information to the image corrector 104a.

Step S24

Next, the image corrector 104a determines rotation accuracy based on the aspect ratio information or the orientation information.

Step S25

Next, the image corrector 104a detects horizontal direction information to be a clue to the horizontal direction in the input image.

Step S26

Next, the image corrector 104a determines a rotation amount by which the image is rotated based on the rotation accuracy determined in step S24 and the horizontal direction information detected in step S25.

Step S27

Next, the image corrector 104a rotates the input image based on the rotation amount determined in step S26, and generates a rotationally corrected output image.

Step S28

Next, the image corrector 104a causes the display unit 2 to output the generated output image.

### 3. One Example of Correction

The correction performed by the image corrector 104a of the image processing device 1a will be specifically described below. The image corrector 104a switches the rotation accuracy of the input image in accordance with the aspect ratio of the image or the orientation of the imaging device at the time of having imaged the input image. Here, a case that the image corrector 104a switches the rotation accuracy of the input image based on the aspect ratio will be described. Note that in a case of switching the rotation accuracy of the input image based on the aspect ratio, the image corrector 104a switches, in a case that the aspect ratio of the input image and the aspect ratio of the output image are the same, the rotation accuracy of the input image in consideration of the aspect ratio of the input image (=the aspect ratio of the output image), and switches, in a case that the aspect ratio of the input image and the aspect ratio of the output image are different, the rotation accuracy of the input image in consideration of the aspect ratio of the output image. Hereinafter, a case that the aspect ratio of the input image and the aspect ratio of the output image are the same, that is, the rotation correction in consideration of the aspect ratio of the input image will be specifically described.

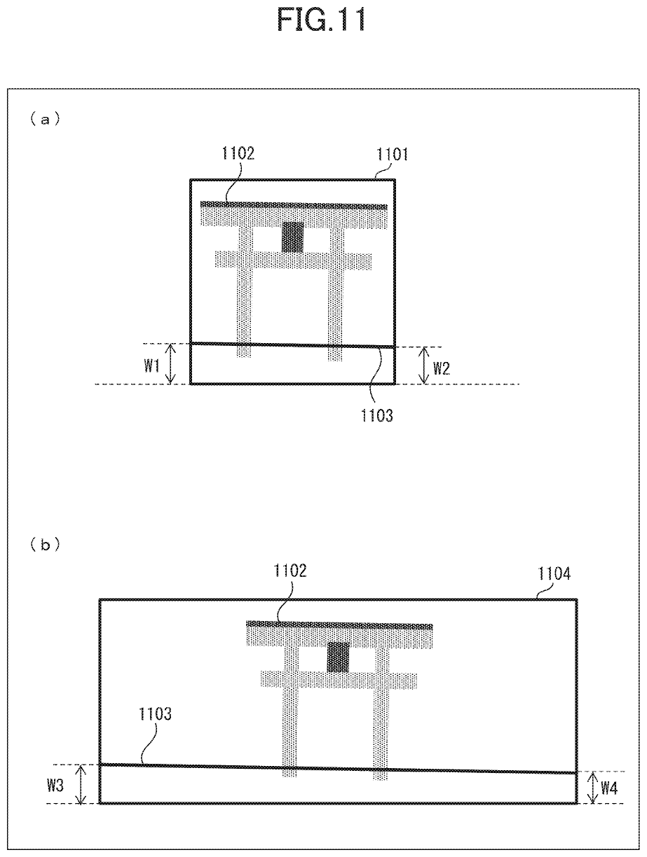

First, a relationship between the aspect ratio and the rotation accuracy will be described. (a) of FIG. 11 illustrates an input image 1101 with an aspect ratio of 1:1, and (b) of FIG. 11 illustrates an input image 1104 with an aspect ratio of 21:9. In the input images 1101 and 1104, an imaging object 1102 and a horizontal line 1103 are included, and the image-capturing has been performed in a state that the horizontal line 1103 is tilted by approximately 1° with respect to the lateral direction (horizontal direction) of the input image. The input images 1101 and 1104 have the same tilt of the horizontal line 1103 in the horizontal direction. However, the input image 1104 provides an impression that the horizontal line 1103 is tilted more than the input image 1101. This is because the input image 1104 is an image that is laterally longer than the input image 1101, and the tilt is easy to be recognized.

A width W1 indicated by an arrow on a left side of the input image 1101 indicates a length from an image bottom end of the input image 1101 to the horizontal line 1103, and a width W2 indicated by an arrow on a right side of the input image 1101 indicates a length from an image bottom end of the input image 1101 to the horizontal line 1103. In the same manner, a width W3 indicated by an arrow on a left side of the input image 1104 indicates a length from an image bottom end of the input image 1104 to the horizontal line 1103, and a width W4 indicated by an arrow on a right side of the input image 1104 indicates a length from an image bottom end of the input image 1104 to the horizontal line 1103. The widths from the image bottom end to the horizontal line 1103 are different between the left and right in both of the input images 1101 and 1104, but a difference between the width W3 and the width W4 is greater than a difference between the width W1 and the width W2. Accordingly, the tilt of the horizontal line 1103 in the input image 1104 is easier to be recognized than that in the input image 1101. That is, the laterally longer the aspect ratio of the image is, the easier the tilt of the horizontal line is recognized, and therefore, in the correction of the composition of the input image, in a case that the aspect ratio is laterally long, the accuracy of horizontal correction becomes important.

Accordingly, in the present embodiment, the image corrector 104a changes a processing method and the accuracy of the horizontal correction (that is, the rotation accuracy of the image) in accordance with the aspect ratio of the image. This makes it possible, even in the composition of a laterally long aspect ratio in which the tilt of the horizontal line is easily recognized, to generate an output image with a suitable composition in which the horizontality is accurately corrected.

An example of a method of correcting the tilt of the horizontal line of an image will be described. In a case that the imaging device includes an acceleration sensor, the degree of tilt of the imaging device at the time of having imaged with respect to the vertical direction can be detected, but the acceleration sensor cannot always precisely detect the degree of tilt of the imaging device with respect to the horizontal direction, and displacement from the horizontal direction may occur in the image corrected based on a tilt angle detected by the acceleration sensor. Accordingly, in order to perform the horizontal correction with good accuracy, the image corrector 104a of the image processing device 1a detects information to be a clue to the horizontal direction (horizontal direction information) from the image and performs the horizontal correction based on the detected horizontal direction information. The horizontal direction information in the input image includes a straight line in the input image, an orientation of the face of the person, and the like.

As an example, the horizontal correction method using a straight line in the input image as the horizontal direction information will be described below with reference to FIG. 11. Although, there are multiple straight lines suggesting the horizontal direction in the input image 1101, here, the image corrector 104a is assumed to detect the horizontal line 1103 as the straight line for the horizontal correction. Similarly, the image corrector 104a detects the horizontal line 1103 as the straight line for the horizontal correction from the input image 1104. Then, the image corrector 104a can perform correction, by rotating the image such that the horizontal line 1103 is parallel to the lateral direction of the input image, to a composition in which the horizontal line 1103 in the image is parallel to the lateral direction of the image.

In a case of performing the horizontal correction through the above-described method, the image processing device 1a switches the rotation accuracy in accordance with the aspect ratio of the image. In the present embodiment, the rotation accuracy refers to a resolution of a rotation angle at the time of detecting the tilt angle in the horizontal direction based on the horizontal direction information. In an aspect, as the aspect ratio of the image is laterally longer, the image processing device 1a increases the resolution of a tilting degree of the straight line detected from the input image as the horizontal direction information. Specifically, for example, the image processing device 1a detects the tilt angle of the straight line with 1° accuracy from the input image 1101 with the aspect ratio of 1:1. In contrast, the image processing device 1a detects the tilt angle of the straight line with 0.5° accuracy, which is higher in angular accuracy, from the laterally long input image 1104 with the aspect ratio of 21:9.

With this, as the angular accuracy of the straight line is higher, a suitable output image in which the tilt of the straight line is precisely corrected can be generated. On the other hand, as the angular accuracy of the straight line is lower, the correction accuracy of the tilt of the straight line decreases, but in a case that the aspect ratio of the image is not laterally long, it is difficult to recognize the tilt of the horizontal line, and thus a minute tilt is not easily recognized. Reducing the angular accuracy of the tilt of the straight line has the following effect. The straight line can be detected by known methods such as Hough transformation or the like, but the higher the angular accuracy (the resolution of the rotation angle) is made, the larger the amount of processing of the image becomes, and the longer the processing time becomes. Therefore, in a case that the aspect ratio of the image is not laterally long, by reducing the angular accuracy, the amount of processing is reduced and high speed processing is possible, which is suitable.

Note that in a case that the image processing device 1a switches the rotation accuracy of the input image in accordance with the orientation of the imaging device at the time of having imaged the input image in place of the aspect ratio of the input image, in a case that the orientation of the imaging device at the time of having imaged the input image is the portrait orientation (the orientation in which the vertically long image is imaged), the description in the case that the aspect ratio of the input image is vertically long is applied to the processing of the image processing device 1a. Furthermore, in a case that the orientation of the imaging device at the time of having imaged the input image is the landscape orientation (the orientation in which the laterally long image is imaged), the description in the case that the aspect ratio of the input image is laterally long is applied to the processing of the image processing device 1a.

### Embodiment 4

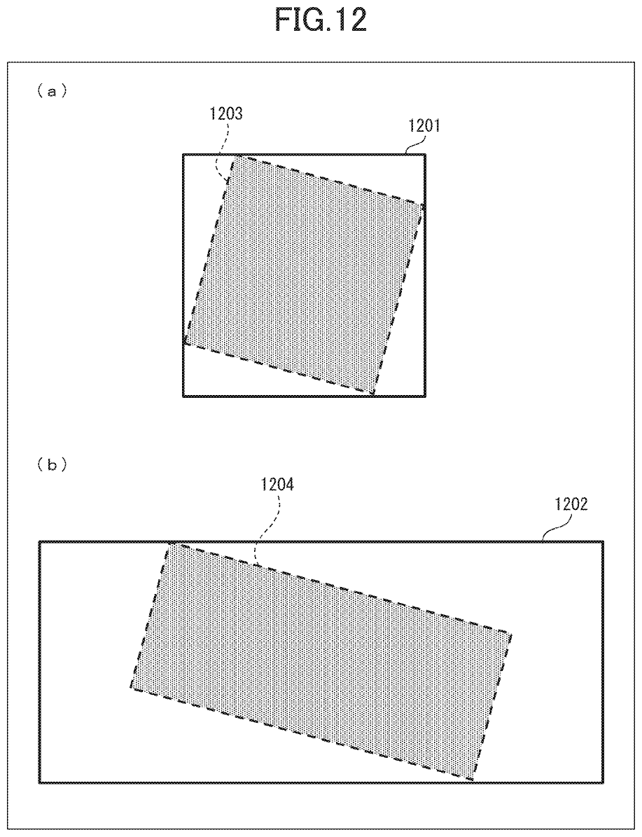

Embodiment 4 of the present invention will be described below with reference to FIG. 12. Note that for the sake of convenience of description, members having the same function as the members described in the above embodiments are denoted by the same reference signs, and descriptions thereof will be omitted. An image processing device according to the present embodiment has the same configuration as that of the image processing device 1a according to Embodiment 3, but is different therefrom in the operation of the image corrector 104a.

In an aspect, the image corrector 104a may change the maximum value of a correctable rotation amount in accordance with the aspect ratio of the input image. (a) of FIG. 12 illustrates an input image 1201 with an aspect ratio of 1:1, and (b) of FIG. 12 illustrates an input image 1202 with an aspect ratio of 21:9. An area 1203 surrounded by a dashed line in the input image 1201 indicates the maximum rectangle that fits within the input image 1201 among rectangles each of which has an aspect ratio of 1:1 and is rotated by 15° with respect to the lateral direction of the input image 1201. In the same manner, an area 1204 surrounded by a dashed line in the input image 1202 indicates the maximum rectangle that fits within the input image 1202 among rectangles each of which has an aspect ratio of 21:9 and is rotated by 15° with respect to the lateral direction of the input image 1202.

The area 1203 and the area 1204 respectively have rectangular shapes tilted by 15° with respect to the lateral direction of the input image, but have different area ratios to the input image. Specifically, the area 1204 has a smaller area ratio to the input image than that of the area 1203. That is, as the aspect ratio of the input image is laterally longer, even in a case that the rotation amounts are the same, a reduction rate of the area of the output image obtained by the rotation correction to the input image increases. As a result, a reduction rate of the angle of view of the output image obtained by the rotation correction to the input image increases. Accordingly, as the aspect ratio of the input image is laterally longer or vertically longer, by the image corrector 104a configuring the maximum value of the rotation amount to be small, the decrease in the angle of view of the output image to the input image can be reduced.

Furthermore, the image corrector 104a may change an evaluation method of the rotation amount in accordance with the aspect ratio of the input image. For example, as the aspect ratio of the input image is closer to the square, the decrease in the angle of view of the output image due to the rotation correction is small, and therefore the evaluation method with small decrease in the evaluation to the increase in the rotation amount (rotation angle) is used. In contrast, as the aspect ratio of the input image is laterally longer or vertically longer, the decrease in the angle of view of the output image due to the rotation correction is large, and therefore the evaluation method with large decrease in the evaluation to the increase in the rotation amount (rotation angle) is used. In one embodiment, in a case that the aspect ratio of the input image is laterally long or vertically long, the image corrector 104a configures the score so as to be lower to the increase in the rotation amount (rotation angle) than in a case that the aspect ratio of the input image is 1:1. As a result, in a case that the aspect ratio of the input image is laterally long or vertically long, an excessive rotation correction is not easily performed, and the output image with a wide angle of view is easily generated.

### Embodiment 5

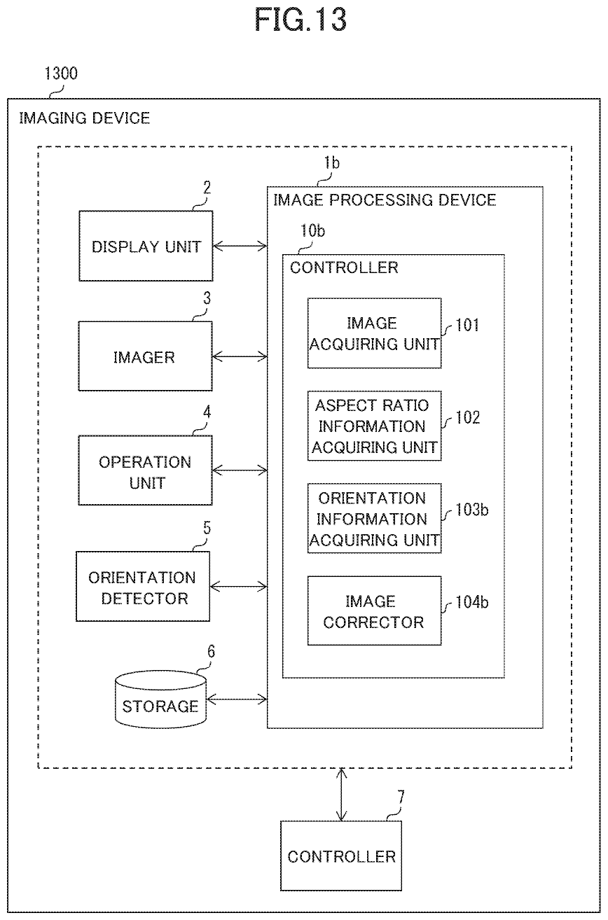

An image processing device 1b according to Embodiment 5 of the present invention will be described below in detail with reference to FIG. 13 to FIG. 17. Note that for the sake of convenience of description, members having the same function as the members described in the above embodiments are denoted by the same reference signs, and descriptions thereof will be omitted.

### 1. Configuration of Main Portions of Image Processing Device 1b

FIG. 13 is a functional block diagram illustrating a configuration of main portions of an imaging device 1300 including the image processing device 1b according to the present embodiment. As illustrated in FIG. 13, the imaging device 1300 includes the image processing device 1b, the display unit 2, an imager 3, an operation unit 4, an orientation detector 5, a storage 6, and a controller 7.

The imager 3 images an imaging object, and transmits the imaged image as an input image to the image processing device 1b.

The operation unit 4 receives a user input, and is implemented by, for example, physical buttons and a touch panel. For example, in a case that the operation unit 4 is a touch panel, the configuration is such that the operation unit 4 is provided on the display unit 2, an operation screen is displayed on the display unit 2, a user operation is received. The operation received by the operation unit 4 includes, for example, a capturing indication, various capturing configurations such as an exposure configuration and the like, storing and deleting captured images, an indication for performing processing in the image processing device 1b, and the like.

The display unit 2 displays the image imaged by the imager 3 or the output image generated by an image corrector 104b of the image processing device 1b. Furthermore, the display unit 2 may display operation information and the like, and the various capturing configurations at the time of capturing and the like, received by the operation unit 4.

The orientation detector 5 detects the orientation of the imaging device 1300 at the time of having imaged the input image (whether the imaging device was in the portrait orientation or in the landscape orientation). The orientation detector 5 detects, for example, by including an acceleration sensor, a tilt of the imaging device 1300 to the gravity direction. As a result, the orientation detector 5 can detect whether the imaging device 1300 is held in the portrait orientation or is held in the landscape orientation.

The storage 6 is configured to store various control programs and the like performed by the image processing device 1b, for example, and includes a non-volatile storage device such as a hard disk and a flash memory. The storage 6 stores the input image and the output image, for example. Additionally, the storage 6 may store parameters and the like necessary for the processing of the image processing device 1b, such as the image processing (composition correction processing), imaging object detection processing, and the like.

The controller 7 comprehensively controls the imaging device 1300. The controller 7 performs controlling each portion included in the imaging device 1300, for example, such as controlling the imager 3 based on an imaging indication received by the operation unit 4, controlling the orientation of the image displayed on the display unit 2 based on the tilt of the imaging device 1300 detected by the orientation detector 5, and the like.

Furthermore, the processing and the controlling can be implemented by software processing performed by a Central Processing Unit (CPU) and a Graphics Processing Unit (GPU), or hardware processing performed by an Application Specific Integrated Circuit (ASIC) and a Field Programmable Gate Array (FPGA).

The image processing device 1b performs image processing for performing projective transformation in which an image is rotated around a specific axis as the center on an input image input to the image processing device 1b, and generates an image after correction (output image). As illustrated in FIG. 13, the image processing device 1b differs from the image processing device 1 according to Embodiment 1 in a point that a controller 10b includes the image corrector 104b instead of the image corrector 104, in a point that the controller 10b further includes an orientation information acquiring unit 103b, and in a point that the controller 10b is connected to the storage 6 outside the image processing device 1b instead of the storage 20. With the configuration described above, the image processing device 1b is capable of switching a rotating axis of the projective transformation for the input image in accordance with the aspect ratio of the input image or the output image, or the orientation of the imaging device at the time of having imaged the input image.

The orientation information acquiring unit 103b acquires orientation information indicating the orientation of the imaging device at the time of having imaged the input image detected by the orientation detector 5 (whether the imaging device was in the portrait orientation or in the landscape orientation).

The image corrector 104b determines the rotating axis of the projective transformation for the input image based on the aspect ratio information acquired by the aspect ratio information acquiring unit 102 or the orientation information acquired by the orientation information acquiring unit 103b. Furthermore, the image corrector 104b performs the projective transformation on the input image with respect to the determined rotating axis of the projective transformation, and generates a corrected output image.

### 2. Operation of Image Processing Device 1b

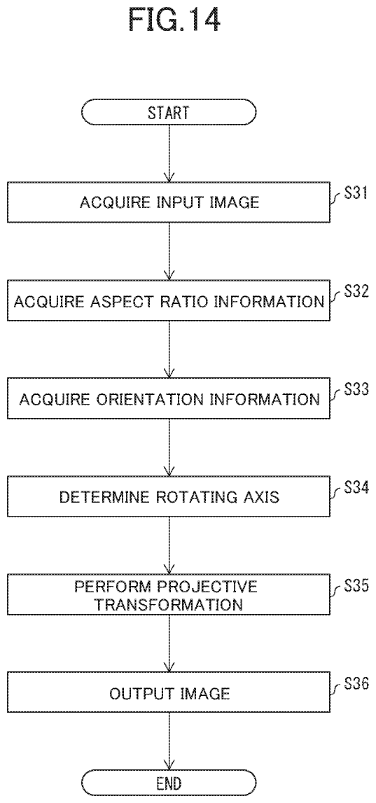

FIG. 14 is a flowchart illustrating an example of operations performed by the image processing device 1b.

Step S31

First, the image acquiring unit 101 acquires an input image. The image acquiring unit 101 supplies the acquired input image to the aspect ratio information acquiring unit 102 and the image corrector 104b.

Step S32

Next, the aspect ratio information acquiring unit 102 acquires information on an aspect ratio of the input image or an output image. The aspect ratio information acquiring unit 102 supplies the acquired aspect ratio information to the image corrector 104b.

Step S33

Next, the orientation information acquiring unit 103b acquires orientation information indicating the orientation of the imaging device at the time of having imaged the input image detected by the orientation detector 5 (whether the imaging device is in the portrait orientation or in the landscape orientation). The orientation information acquiring unit 103b supplies the acquired orientation information to the image corrector 104b.

Step S34

Next, the image corrector 104b determines a rotating axis of projective transformation based on the aspect ratio information or the orientation information.

Step S35

Next, the image corrector 104b performs the projective transformation on the input image with respect to the rotating axis determined in step S34, and generates a corrected output image.

Step S36

Next, the image corrector 104a causes the display unit 2 to output the generated output image.

### 3. One Example of Correction

The correction performed by the image corrector 104b of the image processing device 1b will be specifically described below. The image corrector 104b switches the rotating axis of the projective transformation for the input image in accordance with the aspect ratio of the image or the orientation of the imaging device at the time of having imaged the input image. Here, a case that the image corrector 104b switches the rotating axis of the projective transformation for the input image based on the aspect ratio will be described. Note that at the time of switching the rotating axis of the projective transformation for the input image based on the aspect ratio, the image corrector 104b (i) switches, in a case that the aspect ratio of the input image and the aspect ratio of the output image are the same, the rotating axis of the projective transformation for the input image based on the aspect ratio of the input image (=the aspect ratio of the output image), and (ii) switches, in a case that the aspect ratio of the input image and the aspect ratio of the output image are different, the rotating axis of the projective transformation for the input image based on the aspect ratio of the output image. Hereinafter, a case that the aspect ratio of the input image and the aspect ratio of the output image are the same, that is, a case that the projective transformation for the input image is performed based on the aspect ratio of the input image will be specifically described.

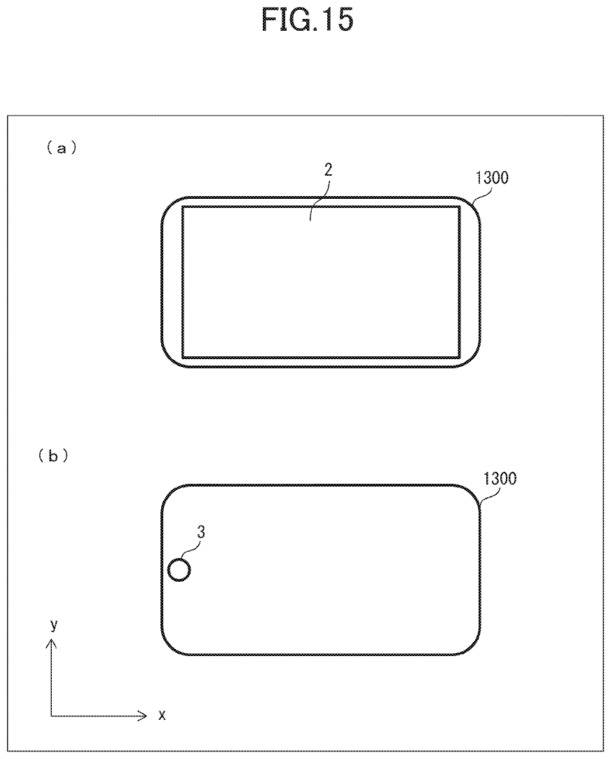

First, a relationship between the aspect ratio and the rotating axis of the projective transformation will be described. FIG. 15 includes diagrams illustrating a visual appearance of the imaging device 1300. (a) of FIG. 15 illustrates a front surface of the imaging device 1300, and (b) of FIG. 15 illustrates a rear surface of the imaging device 1300. As illustrated in (a) of FIG. 15, the display unit 2 is provided on the front surface of the imaging device 1300. Furthermore, as illustrated in (b) of FIG. 15, the imager 3 is provided on the rear surface of the imaging device 1300. An x-axis direction in FIG. 15 indicates the vertical direction of the imaging device 1300, and a y-axis direction indicates the lateral direction of the imaging device 1300.

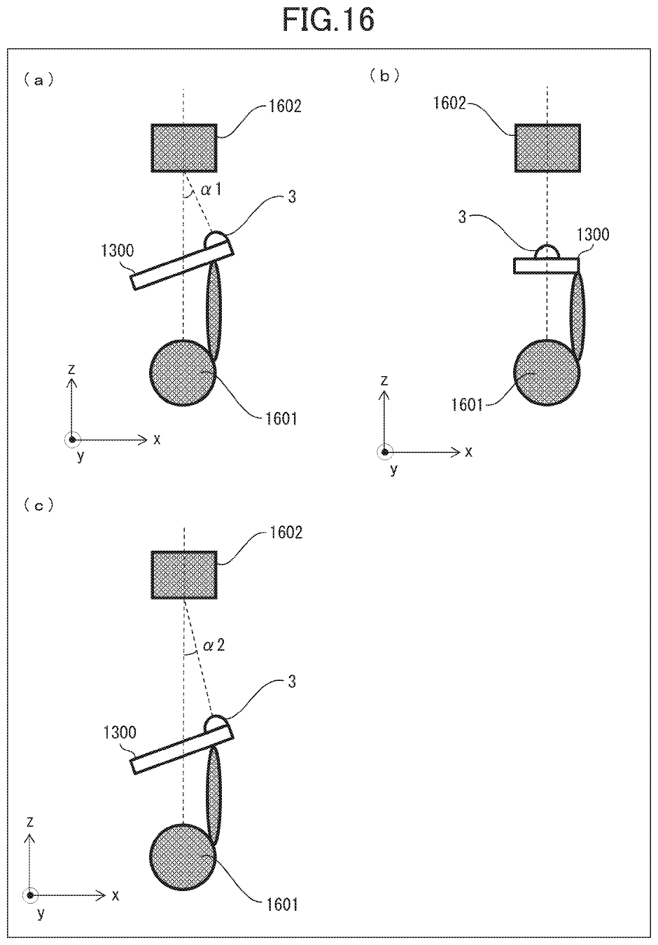

FIG. 16 includes diagrams each of which illustrates a state in which a photographer 1601 holds the imaging device 1300 to capture an imaging object 1602. (a) and (c) of FIG. 16 illustrate overhead views from the above of states in each of which the photographer 1601 holds the imaging device 1300 in the landscape orientation (so as to image a laterally long image) and captures the imaging object 1602, and (b) of FIG. 16 illustrates an overhead view from the above of a state in which the photographer 1601 holds the imaging device 1300 in the portrait orientation (so as to image a vertically long image) and captures the imaging object 1602. In (a) and (c) of FIG. 16, the distances between the imaging device 1300 and the imaging object 1602 are changed to perform image-capturing. In (a) to (c) of FIG. 16, the photographer 1601 performs image-capturing at a position where the photographer 1601, the center of the imaging device 1300, and the imaging object 1602 are aligned on a straight line.

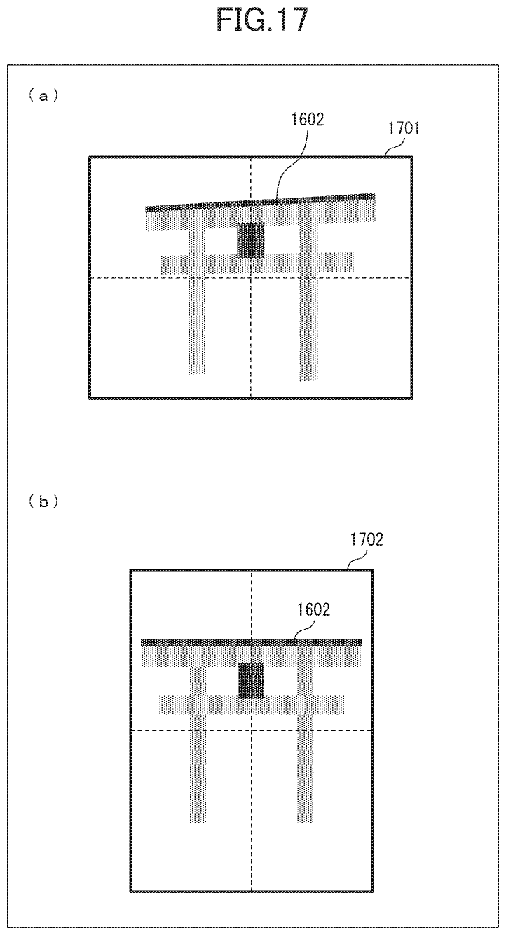

As illustrated in (a) to (c) of FIG. 16, in a case of consciously capturing the imaging object 1602 so as to be located at the center of the captured image, the image-capturing may be performed in a state in which the photographer 1601, the center of the imaging device 1300, and the imaging object 1602 are located on the straight line. However, in a case that an imaging device, such as the imaging device 1300, in which the imager 3 is not centrally located in a case of being held in the landscape orientation is used, as illustrated in (a) of FIG. 16, the imaging object 1602 is captured from an oblique direction in some cases. Explaining this based on an axial direction illustrated in (a) of FIG. 16, in (a) of FIG. 16, rotation with they axis as the center occurs in the orientation of the imaging device 1300 to the imaging object 1602. (a) of FIG. 17 illustrates a captured image 1701 in a case that the imaging object 1602 is captured under the condition illustrated in (a) of FIG. 16. In the captured image 1701, the imaging object 1602 is captured with a tilt. On the other hand, in (b) of FIG. 16, the image-capturing is performed while directly facing the imaging object 1602. Accordingly, the rotation with the y axis as the center does not occur in the orientation of the imaging device 1300 to the imaging object 1602. (b) of FIG. 17 illustrates a captured image 1702 in a case that the imaging object 1602 is captured under the condition illustrated in (b) of FIG. 16. In the captured image 1702, the imaging object 1602 is captured without a tilt. Since the imaging object 1602 is an imaging object with high symmetry, by being captured in the symmetry composition, an image with a suitable impression is obtained. However, as illustrated in (a) of FIG. 16, in a case of being captured from the oblique direction, an image with low symmetry is obtained. Such an image cannot be corrected to an image directly facing the imaging object 1602, such as the captured image 1702, by the known affine transformation such as parallel movement, rotation, or the like. Accordingly, by the known method, the captured image 1701 cannot be corrected to an image with high symmetry. In order to correct the captured image 1701 to an image with high symmetry such as the captured image 1702, the image corrector 104b needs to perform the projective transformation that rotates the imaging object 1602 with the y axis as the center in consideration of image-capturing from the right oblique direction.

Therefore, while taking into consideration the orientation of the imaging device at the time of having imaged the input image, which is assumed from the aspect ratio of the input image, the image processing device 1b performs the correction including the projective transformation, then performs a composition evaluation, and generates an output image with a suitable composition. For example, in (a) of FIG. 16, since the imaging device 1300 is held in the landscape orientation, the captured image is captured so as to have the laterally long aspect ratio. Furthermore, since, in the imaging device 1300, the imager 3 is not located at the center of the imaging device, as illustrated in (a) of FIG. 16, in a case that the image-capturing is performed under the condition in which the imaging device 1300 is held in the landscape orientation such that the imager 3 is located on the right side facing the imaging object 1602, there is high possibility that the imaging object 1602 is captured from the right oblique direction. Therefore, in a case of evaluating the captured image 1701 to select the optimum composition, the image corrector 104b may perform, so as to cancel out the tilt of the imaging device 1300 that occurs in a case of being captured from the right oblique direction, an evaluation including an image that has been subjected to the projective transformation for correcting the rotation with the y axis as the center, and may select the most suitable composition. Note that the rotation angle in the projective transformation is not particularly limited and results respectively obtained by rotating by multiple predetermined angles may be output.

The captured image 1701 is likely to be captured from the right oblique direction, but the tilt angle varies depending on a positional relationship between the imaging device 1300 and the imaging object 1602, such as a distance to the imaging object 1602 or the like. For example, In (a) and (c) of FIG. 16, the distances between the imaging device 1300 and the imaging object 1602 are different from each other. In this case, a tilt angle α1 of the imaging device 1300 to the imaging object 1602 in a case that the imaging object 1602 is captured under the condition of (a) of FIG. 16 is greater than a tilt angle α2 of the imaging device 1300 to the imaging object 1602 in a case that the imaging object 1602 is captured under the condition of (c) of FIG. 16. Accordingly, by evaluating the image that has been subjected to the projective transformation with multiple rotation amounts, there is possibility that an image that has been subjected to the optimum projective transformation can be generated. For example, in the imaging conditions of (a) and (c) of FIG. 16, the image that has been subjected to the optimum projective transformation has high symmetry, and therefore, the symmetry composition is easily selected as a suitable composition, from among images that have been subjected to the projective transformation with the multiple rotation amounts. In one embodiment, configuring the score of the symmetry composition to the highest score among candidate images that have been subjected to the projective transformation with the multiple rotation amounts makes it easier to select the image with the symmetry composition as the optimum image from among the candidate images. Furthermore, in another embodiment, it is possible for a user to select the optimum image from among the candidate images that have been subjected to the projective transformation with the multiple rotation amounts. Furthermore, in another embodiment, it is also possible for the user to select the optimum rotation amount of the projective transformation.

On the other hand, in a case of image-capturing under the condition of (b) of FIG. 16, since the imager 3 is located on the upper side or the lower side relative to the center of the imaging device 1300, there is a possibility that a tilt in the up and down direction with respect to the imaging object 1602 occurs. That is, there is possibility that rotation with the x axis as the center occurs in the orientation of the imaging device 1300 to the imaging object 1602. Therefore, in a case of evaluating the captured image 1702 to select the optimum composition, the image corrector 104b may perform, so as to cancel out the tilt of the imaging device 1300 that occurs in a case of being captured from the upper oblique direction or lower oblique direction, an evaluation including an image that has been subjected to the projective transformation for correcting rotation with the x axis as the center, and may select the most suitable composition.

Since the rotation with the x axis as the center is the tilt to the gravity direction, the image corrector 104b may perform evaluation with the tilt of the imaging device 1300 to the gravity direction. For example, the image corrector 104b may correct the tilt with the x axis as the center based on the tilt of the imaging device to the gravity direction, may further perform rotation correction with the x axis as the center for the image, then may perform a composition evaluation, and may select a suitable composition. In addition, the image corrector 104b simultaneously processes the above-described two times of x-axis rotations and then evaluates the composition, whereby the amount of processing can be reduced, which is suitable.

As described above, in the image processing device 1b, while taking into account the orientation of the imaging device 1300 to the imaging object at the time of image-capturing due to the difference in the aspect ratio of the image, by switching the rotating axis of the projective transformation and performing the projective transformation, the image corrector 104b can generate the output image resulting from the projective transformation appropriate to the aspect ratio. Note that in a case of switching the rotating axis of the projective transformation in accordance with the orientation of the imaging device at the time of having imaged the input image in place of the aspect ratio of the input image, in a case that the orientation of the imaging device at the time of having imaged the input image is the portrait orientation, the captured image (input image) becomes vertically long, and therefore the description in the case that the aspect ratio of the input image is vertically long is applied to the processing of the image corrector 104b. Furthermore, in a case that the orientation of the imaging device at the time of having imaged the input image is the landscape orientation, the captured image (input image) becomes laterally long, and therefore the description in the case that the aspect ratio of the input image is laterally long is applied to the processing of the image corrector 104b.

### Embodiment 6

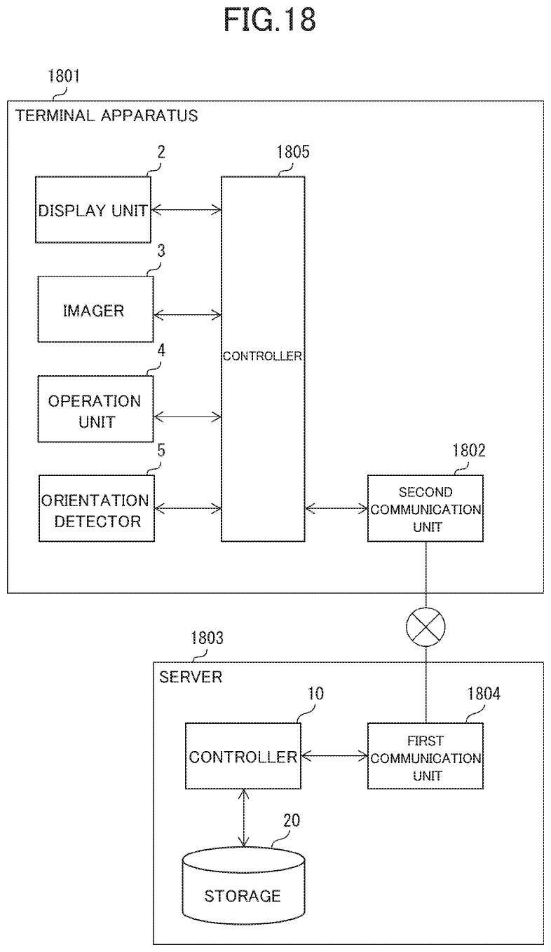

A terminal apparatus 1801 and a server 1803 according to Embodiment 6 of the present invention will be described below in detail with reference to FIG. 18.

FIG. 18 is a block diagram illustrating a configuration of main portions of the terminal apparatus 1801 and the server 1803 according to the present embodiment.

The server 1803 includes the controller 10, the storage 20, and a first communication unit 1804. The controller 10 generates an output image based on the input image and information indicating the orientation of the imaging device at the time of having imaged the input image, received from the terminal apparatus 1801 via the first communication unit 1804, and transmits the generated image to the terminal apparatus 1801 via the first communication unit 1804.

The terminal apparatus 1801 includes the display unit 2, the imager 3, the operation unit 4, the orientation detector 5, a second communication unit 1802, and a controller 1805. The controller 1805 transmits the image imaged by the imager 3, as an input image, as information indicating an orientation detected by the orientation detector 5 at the time of imaging by the imager 3 and the information indicating the orientation of the imaging device at the time of having imaged the input image, to the server 1803 via the second communication unit 1802, and receives the output image processed by (the controller 10 of) the server 1803 via the second communication unit 1802.

The terminal apparatus 1801 and the server 1803 are connected through a communication network.

With the configuration described above as well, effects similar to those of the other embodiments can be obtained.

### Implementation Examples by Software

The control blocks (especially the image correctors 104, 104a, and 104b) of the image processing devices 1, 1a, and 1b may be achieved with a logic circuit (hardware) formed as an integrated circuit (IC chip) or the like, or with software using a Central Processing Unit (CPU).

In the latter case, the image processing devices 1, 1a, and 1b include a CPU performing instructions of a program that is software implementing the functions, a Read Only Memory (ROM) or a storage device (these are referred to as recording media) in which the program and various data are stored to be readable by a computer (or CPU), a Random Access Memory (RAM) in which the program is deployed, and the like. The computer system (or CPU) reads from the recording medium and performs the program to achieve the object of the present invention. As the above-described recording medium, a “non-transitory tangible medium” such as a tape, a disk, a card, a semiconductor memory, and a programmable logic circuit can be used. The above-described program may be supplied to the above-described computer via an arbitrary transmission medium (such as a communication network and a broadcast wave) capable of transmitting the program. Note that one aspect of the present invention may also be implemented in a form of a data signal embedded in a carrier wave in which the program is embodied by electronic transmission. The “computer system” here includes an OS and hardware components such as a peripheral device. Further, the “computer system” includes environment for supplying a home page (or environment for display) in a case of utilizing a WWW system.

### Supplement

An image processing device (1, 1a, 1b, controller 10) according to Aspect 1 of the present invention includes an image corrector (104, 104a, 104b) configured to perform at least one correction of cut-out, rotation, and projective transformation on an input image to generate an output image, in which the image corrector (104, 104a, 104b) is configured to perform the at least one correction based on an aspect ratio of the input image or the output image, or an orientation of an imaging device (imager 3) at a time when the input image is imaged.

According to the above-described configuration, a suitable output image can be generated.

In the image processing device (1) according to Aspect 2 of the present invention, in Aspect 1 described above, the image corrector (104) may be configured to determine a composition of the output image based on the aspect ratio of the input image or the output image.

According to the above-described configuration, the optimum composition according to the aspect ratio of the image can be determined.

In the image processing device (1) according to Aspect 3 of the present invention, in Aspect 1 described above, the image corrector (104) may be configured to detect imaging object information included in the input image, and correct the input image based on the imaging object information and the aspect ratio of the input image or the output image.

According to the above-described configuration, an output image with the composition according to the aspect ratio of the image can be suitably generated.

In the image processing device (1) according to Aspect 4 of the present invention, in Aspect 1 described above, the image corrector (104) may be configured to limit a cut-off width of the input image in the cut-out in accordance with the aspect ratio of the input image or the orientation of the imaging device (imager 3) at the time when the input image is imaged.

According to the above-described configuration, an output image according to the aspect ratio of the image or the orientation of the imaging device at the time of having imaged the input image can be generated.

In the image processing device (1a) according to Aspect 5 of the present invention, in Aspect 1 described above, the image corrector (104) may be configured to switch accuracy of the rotation in accordance with the aspect ratio of the input image or the output image, or the orientation of the imaging device at the time when the input image is imaged.

According to the above-described configuration, since the accuracy of the rotation is switched in accordance with the aspect ratio of the image or the orientation of the imaging device at the time of having imaged the input image, an output image in which a tilt is appropriately corrected can be generated.

In the image processing device (1a) according to Aspect 6 of the present invention, in Aspect 1 described above, the image corrector (104) may be configured to limit a rotation amount of the rotation in accordance with the aspect ratio of the input image.

According to the above-described configuration, an output image with a wider angle of view according to the aspect ratio of the input image can be generated.

In the image processing device (1b) according to Aspect 7 of the present invention, in Aspect 1 described above, the image corrector (104) may be configured to switch a rotating axis of the projective transformation in accordance with the aspect ratio of the input image or the output image, or the orientation of the imaging device (imager 3) at the time when the input image is imaged.

According to the above-described configuration, since the rotating axis of the projective transformation is switched in accordance with the aspect ratio of the image or the orientation of the imaging device at the time of having imaged the input image, an output image in which a tilt is appropriately corrected can be generated.

The image processing device (controller 10) according to Aspect 8 of the present invention, in any one of Aspects 1 to 7 described above, the image processing device may be configured to further include a first communication unit (1804) configured to receive, from a terminal apparatus (1801), information for indicating the input image and the orientation of the imaging device (imager 3) at the time when the input image is imaged, and transmit the output image to the terminal apparatus (1801).

The terminal apparatus (1801) according to Aspect 9 of the present invention may be configured to include a second communication unit (1802) configured to transmit, to the image processing device (controller 10) according to Aspect 8 of the present invention, information for indicating the input image and the orientation of the imaging device (imager 3) at the time when the input image is imaged, and receive the output image from the image processing device (controller 10).

According to the above-described configuration, by the terminal apparatus and the image processing device communicating to each other, the same effect as that of Aspect 1 can be achieved.

An imaging device (1300) according to Aspect 10 of the present invention is configured to include an imager (3); and the image processing device (1, 1a, 1b) according to any one of Aspects 1 to 7 described above configured to generate the output image by using the image imaged by the imager (3) as the input image.

According to the above-described configuration, the same effect as that of Aspect 1 can be achieved.

The imaging device (1300) according to Aspect 11 of the present invention, in Aspect 10 described above, further includes an orientation detector (5) configured to detect an orientation of the imaging device (1300), in which the image processing device (1, 1a, 1b) generates the output image based on the orientation of the imaging device (1300) detected by the orientation detector (5).

According to the above-described configuration, the output image can be generated based on the orientation of the imaging device at the time of having imaged the input image.

An image correction method according to Aspect 12 of the present invention includes a step of image-correcting in which an image processing device (1, 1a, 1b) at least performs at least one correction selected from a group including cut-out, rotation, and projective transformation on an input image to generate an output image, in which, in the image-correcting, the image processing device (1, 1a, 1b) performs the at least one correction based on an aspect ratio of the input image or the output image, or an orientation of an imaging device (imager 3) at a time when the input image is imaged.

According to the above-described configuration, the same effect as that of Aspect 1 can be achieved.

The image processing device (1, 1a, 1b) according to each of the aspects of the present invention may be implemented by a computer, in this case, the present invention embraces also an image processing program of the image processing device that implements the above image processing device (1, 1a, 1b) by a computer by causing the computer to operate as each unit (software element) included in the above image processing device (1, 1a, 1b), and a computer-readable recording medium recording the program.

The present invention is not limited to each of the above-described embodiments. It is possible to make various modifications within the scope of the claims. An embodiment obtained by appropriately combining technical elements each disclosed in different embodiments falls also within the technical scope of the present invention. Further, when technical elements disclosed in the respective embodiments are combined, it is possible to form a new technical feature.

### CROSS-REFERENCE OF RELATED APPLICATION

This application claims the benefit of priority to JP 2017-079948 filed on Apr. 13, 2017, which is incorporated herein by reference in its entirety.

### REFERENCE SIGNS LIST

1, 1a, 1b Image processing device

3 Imager

5 Orientation detector

104, 104a, 104b Image corrector

1801 Terminal apparatus

1802 Second communication unit

1803 Server (Image processing device)

1804 First communication unit

1300 Imaging device

1. An image processing device comprising:
an image corrector configured to perform at least one correction of cut-out, rotation, and projective transformation on an input image to generate an output image,
wherein the image corrector is configured to perform the at least one correction based on an aspect ratio of the input image or the output image, or an orientation of an imaging device at a time when the input image is imaged.

2. The image processing device according to claim 1,
wherein the image corrector is configured to determine a composition of the output image based on the aspect ratio of the input image or the output image.

3. The image processing device according to claim 1,
wherein, the image corrector is configured to detect imaging object information included in the input image, and correct the input image based on the imaging object information and the aspect ratio of the input image or the output image.

4. The image processing device according to claim 1,
wherein the image corrector is configured to, limit a cut-off width of the input image in the cut-out in accordance with the aspect ratio of the input image or the orientation of the imaging device at the time when the input image is imaged.

5. The image processing device according to claim 1,
wherein the image corrector is configured to switch accuracy of the rotation in accordance with the aspect ratio of the input image or the output image, or the orientation of the imaging device at the time when the input image is imaged.

6. The image processing device according to claim 1,
wherein the image corrector is configured to limit a rotation amount of the rotation in accordance with the aspect ratio of the input image.

7. The image processing device according to claim 1,
wherein the image corrector is configured to switch a rotating axis of the projective transformation in accordance with the aspect ratio of the input image or the output image, or the orientation of the imaging device at the time when the input image is imaged.

8. The image processing device according to claim 1, the image processing device further comprising:
a first communication unit configured to receive, from a terminal apparatus, information for indicating the input image and the orientation of the imaging device at the time when the input image is imaged, and transmit the output image to the terminal apparatus.

9. (canceled)

10. An imaging device comprising:
an imager; and
the image processing device according to claim 1, the image, processing device configured to generate the output image by using the image imaged by the imager as the input image.

11. The imaging device according to claim 10, the imaging device further comprising:
an orientation detector configured to detect an orientation of the imaging device,
wherein the image processing device generates the output image based on the orientation of the imaging device detected by the orientation detector.

12. An image correction method comprising a step of:
image-correcting in which an image processing device at least performs at least one correction selected from a group including cut-out, rotation, and projective transformation on an input image to generate an output image,
wherein, in the image-correcting, the image processing device performs the at least one correction based on an aspect ratio of the input image or the output image, or an orientation of an imaging device at a time when the input image is imaged.

13. (canceled)
